(19) United States
(12) Patent Application Publication
(10) Pub. No.: US 2007/0040484 A1
(43) Pub. Date: Feb. 22, 2007

(54) Interlocking structure of drawers

(75) Inventor: Kuo-Sheng Huang, Ying Ghor Town (TW)

Correspondence Address: TROXELL LAW OFFICE PLLC, Suite 1404, 5205 Leesburg Pike, Falls Church, VA, 22041, US

(73) Assignee: Nan Juen International Co., Ltd.

(21) Appl. No.: 11/266,328

(22) Filed: Nov. 4, 2005

(30) Foreign Application Priority Data
Aug. 16, 2005 (TW) 94213903

(51) Int. Cl. E05C 7/06

(52) U.S. Cl. 312/221

(57) ABSTRACT

An interlocking structure of drawers having a fixing bracket, a rotatory cam, two braking slides, and a guide plate is disclosed. The rotatory cam is inserted into a mounting trench of the fixing bracket such that a large pillar of the rotatory cam can be inserted into an arc-shaped limit trench for controlling the angular rotation of the rotatory cam. The braking slides are connected to each other such that a push block of the rotatory cam can push the braking slides outwardly. The guide plate is fixedly mounted at the front end of the sliding means, and a guide slideway is mounted on a lateral surface of the guide plate corresponding to the large pillar of the rotatory cam. The large pillar is guided by the guide slideway for movement, and the large pillar is guided by the guide slideway for controlling the angular rotation of the rotatory cam.

### FIELD OF THE INVENTION

The present invention relates to an improved interlocking structure of drawers, and more particularly to a simpler and more stable positioning structure of a rotatory cam.

### BACKGROUND OF THE INVENTION

For many structures of cabinet on which several drawers are mounted, if one of the drawers, which are mounted in parallel, is pulled out of the cabinet, the other drawer mounted above or underneath the pulled drawer may be pulled out simultaneously. Accordingly, an interlocking structure is mounted between two drawers to prevent the other drawers from being pulled out incidentally.

As shown in FIG. 1, a conventional interlocking structure of drawer is shown. A guide plate 1′ is fixedly mounted at the front end of a sliding means. A guide slideway 11′ and an arc-shaped slideway 12′ are formed on a lateral surface of the sliding means. A rotatory shaft 21′, a larger pillar 22′, and a small pillar 23′ are mounted on a rotatory cam 2′, wherein the guide slideway 11′ of the guide plate 1′ is located corresponding to the small pillar 23′ of the rotatory cam 2′, and the arc-shaped slideway 12′ is located corresponding to the large pillar 22′ of the rotatory cam 2′. When separating the guide plate 1′ by slide, the large pillar 22′ of the rotatory cam 2′ is shifted along the arc-shaped slideway 12′, and the small pillar 23′ is shifted along the guide slideway 11′.

During the pull operation of the drawer, the small pillar 23′ is broken easily since the guide slideway 11′ is designed to have small radian. In addition, the guide slideway 11′ has small guide opening so it is not easy to insert the small pillar 23′ into the guide slideway 11′. As a result, the small pillar 23′ is damaged and broken easily.

### SUMMARY OF THE INVENTION

In view of the deficiencies of the conventional structure in which the guide slideway has the small guide opening so it is not easy to insert the small pillar into the guide slideway and the small pillar is thus broken. Accordingly, the present invention provides a single large pillar, wherein the efficacy that this single large pillar achieves is equal to the collective efficacy provided by the conventional large and small pillars. In addition, there is no need to worry about the damage of this single large pillar since it achieves good rotation and positioning results.

### BRIEF DESCRIPTION OF THE DRAWINGS

FIG. 1 is a schematic view showing the conventional assembly relationship between the guide plate and the rotatory cam.

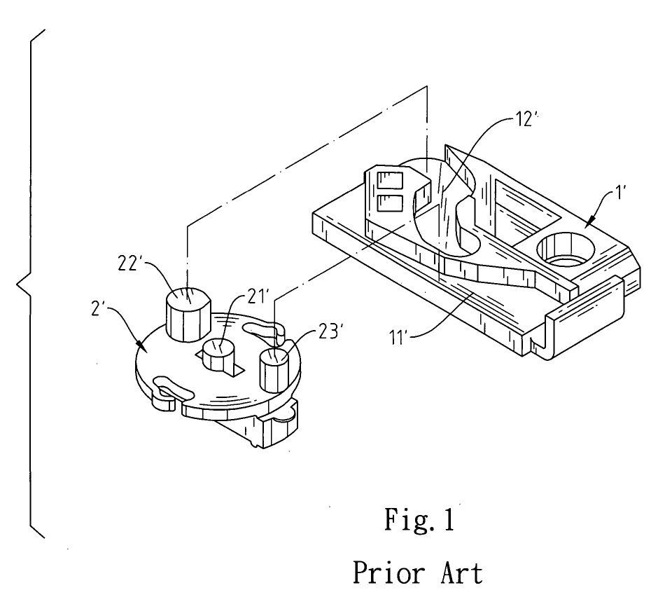

FIG. 2 is a schematic view showing that the braking slides assembled to the fixing bracket are assembled to the track structure in accordance with the present invention.

FIG. 3 is an exploded, elevational view showing the structure shown in FIG. 2.

FIG. 4 is a schematic view showing the assembly of the fixing bracket and the rotatory cam of the present invention.

FIG. 5 is a schematic view showing the assembly relationship among the interlocking structure of drawers, the sliding means and the slideway.

FIG. 6 is a schematic view showing that the push block does not push the braking slides in accordance with the present invention.

FIG. 7 is a schematic view showing the assembly relationship between the guide plate and the rotatory cam of the present invention.

FIG. 8 is a schematic view showing that the block shifts the braking slides in accordance with the present invention.

### DETAILED DESCRIPTION OF THE PREFERRED EMBODIMENT

The above-mentioned features and advantages of this invention, and the manner of attaining them, will become more apparent and the invention will be better understood by reference to the following description of embodiments of the invention taken in conjunction with the drawings.

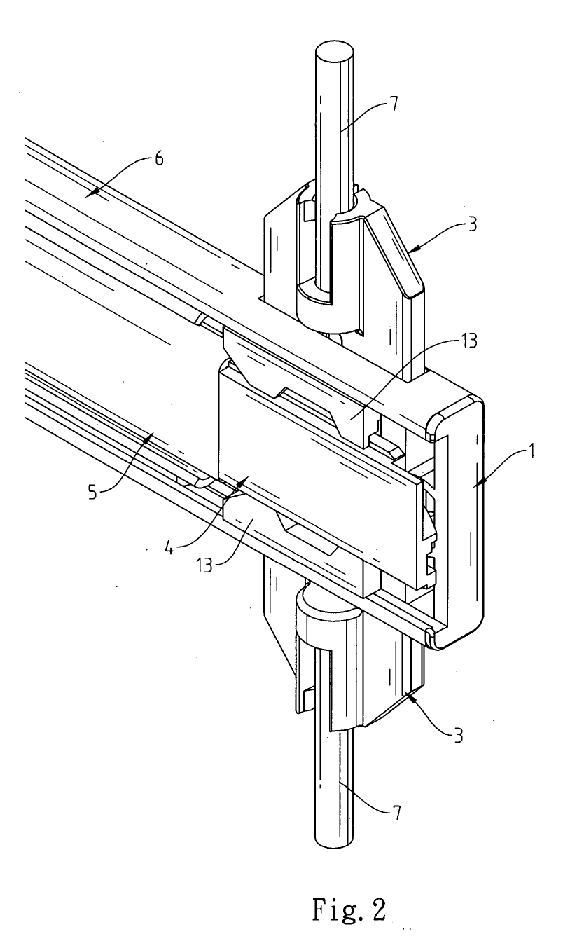

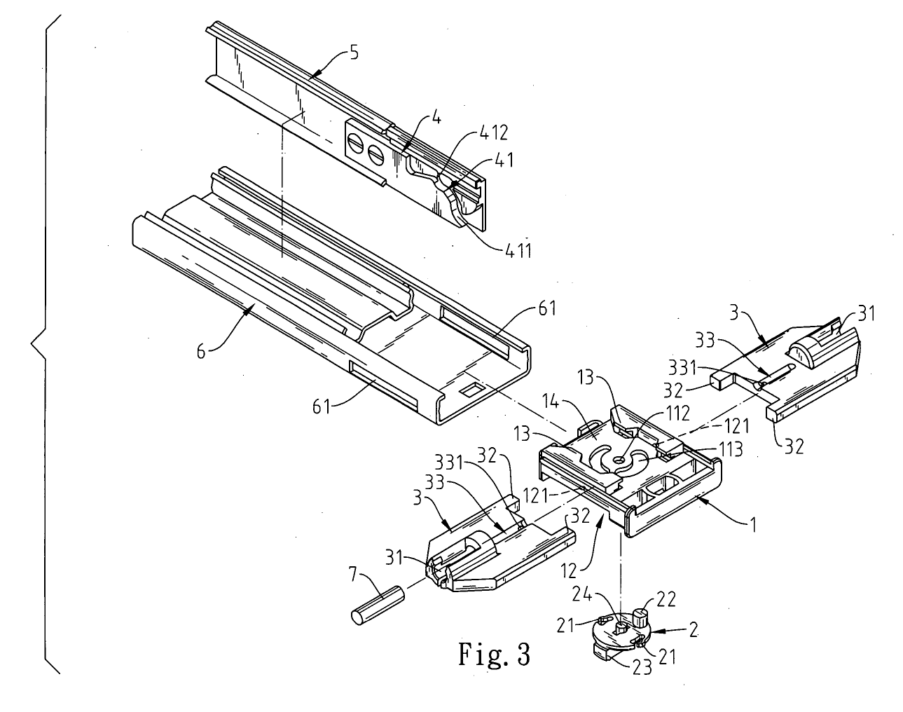

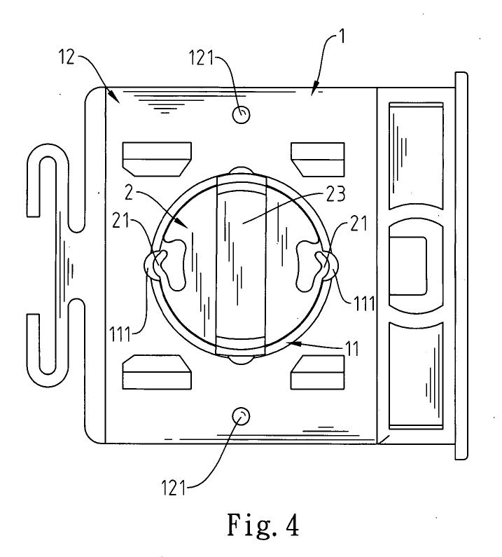

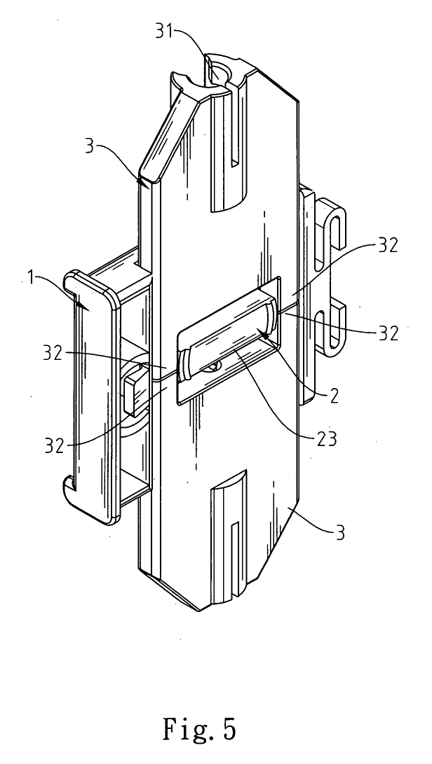

Referring to FIG. 2 through FIG. 5, an interlocking structure of drawers of the present invention comprises a fixing bracket 1, a rotatory cam 2, two braking slides 3, and a guide plate 4.

The fixing bracket 1 is fixedly mounted at one end of a track structure 6. A mounting trench 11 is formed on the center of the fixing bracket 1. Two arc-shaped openings 111 are oppositely formed on the inner edge of the reverse side of an arc-shaped limit trench 113 of the mounting trench 11 respectively. A pivotal hole 112 is formed on the top center of the fixing bracket 1. In addition, a slideway 12 is longitudinally formed on the bottom of the fixing bracket 1. Two raised parts 121 are formed on both sides of the top wall of the slideway 12 respectively. Two holes 61 are formed on the track structure 6 corresponding to the slideway 12. Two blocks 13 are longitudinally mounted on both sides of the top of the fixing bracket 1 respectively. A parallel trench 14 is formed between the positions under the blocks 13 for guiding the insertion of the guide plate 4 so as to mount the guide plate 4.

Two resilient rabbet structures 21 are extended from the opposite outer edges of the rotatory cam 2 respectively. A large pillar 22 is extended from the outer edge of the rotatory cam 2 with equal distance away from these two resilient rabbet structures 21. In addition, a rotatory shaft 24 is protrudent from the center of the rotatory cam 2. A push block 23 is protrudent from the bottom lateral of the rotatory cam 2 such that the top surface of the rotatory cam 2 can be inserted into the mounting trench 11 of the fixing bracket 1 and the rotatory shaft 24 can be inserted into the pivotal hole 112, wherein the larger pillar 22 is inserted into the arc-shaped limit trench 113. Besides, the resilient rabbet structures 21 can be jammed into the arc-shaped openings 111 so the rotatory cam 2 is rotatable over the fixing bracket 1. The rotatory cam 2 is confined to the angular rotation because the insertion of the large pillar 22 is limited by the path provided by the arc-shaped limit trench 113. In addition, if the rotatory cam 2 is rotated, the resilient rabbet structures 21 are correspondingly inserted into the arc-shaped openings 111 such that the rotatory cam 2 can be positioned after the angular rotation.

The braking slides 3 are inserted into the slideway 12 of the fixing bracket 1. An insertion trench 31 of each of braking slides 3 can be connected to and inserted by a brake rod 7 for moving together. Besides, two protrudent parts 32 are extended from two opposite sides of the opposite ends of the braking slides 3 respectively. As a result, the braking slides 3 can be connected to each another so as to form a rectangular trench for holding the push block 23 of the rotatory cam 2.

The protrudent parts 32 of the braking slides 3 are made of symmetric design. As a result, any braking slide 3 can be inserted and mounted in the slideway 12 of the fixing bracket 1 in any direction. Accordingly, there is no need to recognize the direction of insertion during the mounting procedure so the assembly and operation processes are simplified. Therefore, it is very practical and convenient.

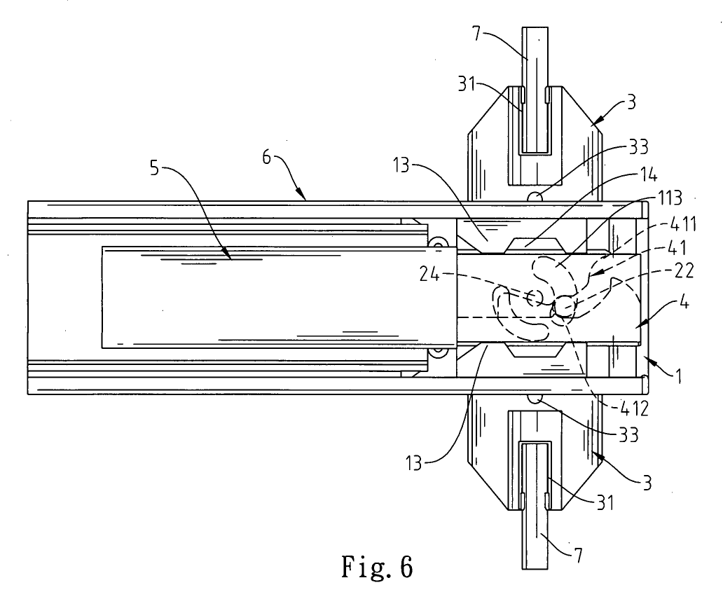

Referring to FIG. 2 and FIG. 6, the guide plate 4 is fixedly mounted at the front end of a sliding means 5. A guide slideway 41 is formed on the lateral surface of the guide plate 4. The guide slideway 41 is divided into a front guide trench 411 and a positioning trench 412. When the sliding means 5 slides toward the fixing bracket 1, the driven guide slideway 41 locates to correspond to the large pillar 22 of the rotatory cam 2.

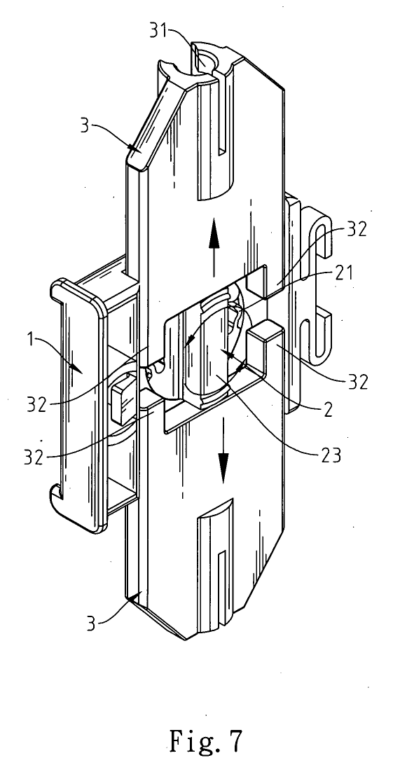

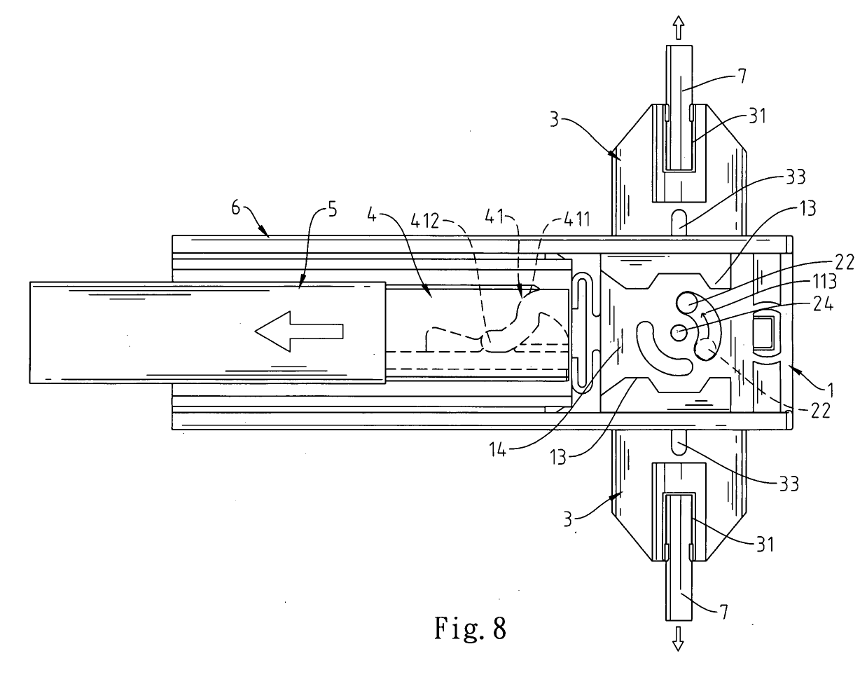

As shown in FIG. 6 through FIG. 8, when the sliding means 5 shifts forward along the slideway formed under the blocks 13 of the fixing bracket 1, if the push block 23 is affected by external factor to maintain the abnormal orientation, the large pillar 22 of the rotatory cam 2 of the present invention is pushed by a slanted surface of the front guide trench 411 of the larger opening of the guide plate 4. As a result, the large pillar 22 is guided to insert into the guide slideway 41 and positioned by the positioning trench 412 so as to maintain the status that the push block 23 of the rotatory cam 2 pushes the braking slides 3 outwardly. As a result, the upper or lower drawer is locked and mounted longitudinally to prevent it from being pulled out. Accordingly, the interlocking structure of drawers of the present invention provides the rotatory cam 2 with the protective design, by which the rotatory cam 2 is guided in advance to enable it to regain its normal position. Therefore, even if the rotatory cam 2 is operated in any improper condition, the push block 23 of the rotatory cam 2 can regain the status that it pushes the braking slides 3 outwardly to lock the upper or lower drawer and to prevent it from being pulled out.

When the sliding means 5 shifts back for closing the drawer, the large pillar of the guide slideway 41 is guided by the front guide trench 411 and the positioning trench 412 such that the push block 23 of the rotatory cam 2 is further rotated so as to shrink the braking slides 3 inwardly, thereby unlocking the upper or lower drawer for pulling it out.

What the invention claimed is:

1. An interlocking structure of drawers having a fixing bracket, a rotatory cam, two braking slides, and a guide plate, the fixing bracket being fixedly mounted at one end of a track structure, a pivotal hole being formed on the top center of the fixing bracket, an arc-shaped limit trench being formed on the top of the fixing bracket, a slideway being longitudinally formed on the bottom of the fixing bracket for insertion of the braking slides, the braking slides being connected to each other so as to form a rectangular trench for holding a push block of the rotatory cam, the guide plate being fixedly mounted at a front end of the sliding means, a guide slideway being formed on a lateral surface of the guide plate corresponding to the rotatory cam, the improvement comprising:
a large pillar being extended from an outer edge of the rotatory cam for being inserted into the arc-shaped limit trench on the top of a mounting trench for controlling an angular rotation path of the rotatory cam, a rotatory shaft being protrudent from the center of the rotatory cam for being inserted into the pivotal hole formed on the top center of the fixing bracket such that the rotatory cam can be inserted into the mounting trench of the fixing bracket for performing rotation by adopting the rotatory shaft as an axis; and
a front guide trench being formed on the guide slideway corresponding to the large pillar of the rotatory cam such that the large pillar is guided by the front guide trench of the guide slideway for driving the rotatory cam and that the large pillar is guided by the guide slideway for controlling the angular rotation of the rotatory cam.

2. The interlocking structure of drawers of claim 1, wherein the front guide trench has a slanted surface.

3. The interlocking structure of drawers of claim 1, wherein the front guide trench has a slanted surface, and the slanted surface can push and guide the large pillar to enable the rotatory cam to perform pivotal rotation and enable the large pillar to be inserted into the guide slideway.
